(19) United States
(12) Patent Application Publication
(10) Pub. No.: US 2024/0220881 A1
(43) Pub. Date: Jul. 4, 2024

(54) Information processing method, information processing system, and program

(71) Applicant: Knowledge Work Inc., Tokyo (JP)

(72) Inventor: Koji ASANO, Tokyo (JP)

(21) Appl. No.: 18/563,376

(22) PCT Filed: Jun. 20, 2022
(86) PCT No.: PCT/JP2022/024451

§ 371 Date: Nov. 22, 2023

(30) Foreign Application Priority Data
Jun. 18, 2021 (JP) 2021-101761

(51) Int. Cl. G06Q 10/0631

(52) U.S. Cl. CPC G06Q 10/063112

(57) ABSTRACT

The information processing method according to the present disclosure is a method that presents to a user appropriate knowledge data among a plurality of knowledge data stored on one or more servers, the method, executed by a processor, comprising: acquiring information regarding a status of the user; identifying at least one knowledge data among the plurality of knowledge data based on the acquired information regarding the status of the user; and outputting information regarding the identified at least one knowledge data.

### TECHNICAL FIELD

This disclosure relates to information processing methods, information processing systems and programs.

### BACKGROUND ART

The importance of sharing more complex knowledge is increasing in the organization's activities. As a technique for a user who is a member of an organization to find his/her desired knowledge, for example, Patent Literature 1 discloses a technique for outputting a business document with a high degree of suitability in the next phase of business by selecting a business case.

### CITATION LIST

### Patent Literature

[PTL 1] Japanese Patent Application Publication No. 2006-039691

### SUMMARY OF INVENTION

### Technical Problem

However, the technology disclosed in the above Patent Literature identifies the knowledge desired by the user himself/herself and does not identify the other knowledge that current user should see.

Accordingly, the present disclosure was made in light of the above problem, and its purpose is to provide information processing methods, information processing systems, and programs that enable to present knowledge, that should be viewed by the user, among the plurality of knowledges.

### Solution to Problem

According to the present disclosure an information processing method that presents to a user appropriate knowledge data among a plurality of knowledge data stored on one or more servers is provided, the method, executed by a processor, comprising: acquiring information regarding a status of the user; identifying at least one knowledge data among the plurality of knowledge data based on the acquired information regarding the status of the user: and outputting information regarding the identified at least one knowledge data.

Further according to the present disclosure, an information processing system that presents to a user appropriate knowledge data among a plurality of knowledge data regarding sales stored on one or more servers is provided, the system comprising: acquiring unit that acquires information indicating a proficiency of the user regarding the sales; identifying unit that identifies at least one knowledge data among the plurality of knowledge data according to the acquired proficiency of the user: and output controlling unit that outputs information regarding the identified at least one knowledge data.

Further according to the present disclosure, a program is provided to make an information processing system, that presents to a user appropriate knowledge data among a plurality of knowledge data regarding sales stored on one or more servers, function as: the program executed by a computer makes the computer function: acquiring unit that acquires information indicating a proficiency of the user regarding the sales: identifying unit that identifies at least one knowledge data among the plurality of knowledge data according to the acquired proficiency of the user: and output controlling unit that outputs information regarding the identified at least one knowledge data.

### Advantageous Effects of Invention

According to this disclosure, the knowledge to be viewed by the user among multiple knowledge can be presented to the user.

### BRIEF DESCRIPTION OF DRAWINGS

FIG. 1 is a figure illustrating a configuration example of the information processing system 1 according to one embodiment of the present disclosure.

FIG. 2 is a figure illustrating an example of a hardware configuration of a computer that implements the server 10 according to the embodiment.

FIG. 3 is a figure illustrating an example of a software configuration of the server 10 according to the embodiment.

FIG. 4 is a figure illustrating an example of the content of the user data stored in the user DB 104 according to the embodiment.

FIG. 5 is a figure illustrating an example of the content of the knowledge data stored in the knowledge DB 105 according to the embodiment.

FIG. 6 is a figure illustrating an example of the content of the customer data stored in the customer DB 106 according to the embodiment.

FIG. 7 is a figure illustrating an example of an aspect of the output display by the output controlling unit 114 according to the embodiment.

FIG. 8 is a flow chart illustrating a series of controls of the information processing system 1 according to the embodiment.

### DESCRIPTION OF EMBODIMENTS

The preferred embodiments of the present disclosure will now be described in detail with reference to the accompanying drawings. In the present specification and drawings, components having substantially the same functional components are omitted by the same reference numerals.

### <Outline of Disclosure>

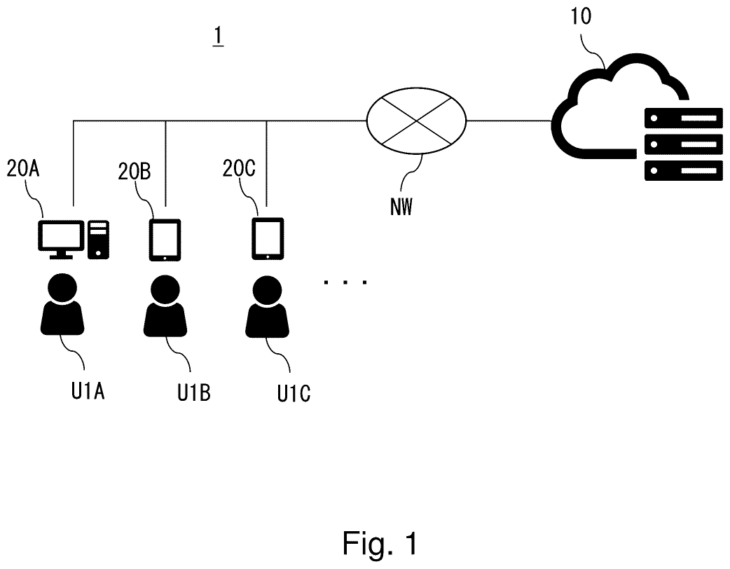

FIG. 1 is a figure illustrating a configuration example of the information processing system 1 according to one embodiment of the present disclosure. As illustrated, the information processing system 1 according to the present embodiment includes an information processing server 10 (hereinafter, referred to as the server 10) and is communicatively connected to the user terminals 20 (20A, 20B, 20C, . . . ) via a network NW. The present configuration is exemplary, and one configuration may have other configurations or other configurations may be included.

In this embodiment, the network NW contemplates the Internet, but it may be a network such as, for example, on-premises or intranet. The network NW may be constructed, for example, by a public telephone network, a cellular telephone network, a wireless communication network, an Ethernet (registered trademark), or the like.

The server 10 is, for example, a computer for managing knowledge shared by organizations such as companies or groups. Such server 10 may be managed, for example, by the above-mentioned organization or by a third party handling other knowledge management services.

For example, the server 10 may be a general purpose computer, such as a workstation or personal computer, or may be logically implemented by cloud computing.

The user terminal 20, for example, is a terminal so that member (user) U1 (U1A, U1B, U1C, . . . ) belonging to an organization accesses knowledge shared in the organization. For example, the user terminal 20 may be a cellular phone, a smartphone, a tablet computer, or a personal computer, or the like.

An outline of the information processing system 1 according to this embodiment will be described. The user U1 tries to acquire the knowledge stored in the database of the server 10 via the user terminal 20. At that time, the knowledge as desired by the user U1 is conventionally retrieved by entering a query by the user U1 to find the desired target knowledge.

However, the knowledge retrieved by the user U1 here is simply what the user U1 would like to see and is not necessarily suitable for the user U1. That is, depending on, for example, the proficiency of the user U1 in the organization or the nature of the task, there may be more appropriate knowledge for the user U1 than the knowledge that the user U1 wishes to see. Such knowledge may not be noticed by the user U1.

Accordingly, the information processing system 1 according to the present embodiment uses the status (for example, information on the attributes and proficiency of the user, the status of the use of the user's knowledge, etc.) of the user U1 belonging to the organization to provide the optimum knowledge. The user's status contains information indicating the status of the user U1 belonging to the organization. By using such status of the user, the appropriate knowledge can be presented to the user U1 according to the situation of the user U1. For example, if the user U1 has not yet been made a sales call to the customer C1, the information processing system 1 may present the information of the customer C1 and knowledge on the environment surrounding the customer C1 to the user terminal 20. This ensures that the user U1 has the knowledge to look for, which is appropriate to the situation of the user U1, compared to the case where the user U1 is looking for his or her own knowledge. Hereinafter, details of the present embodiment will be described.

### <Hardware Configuration Example>

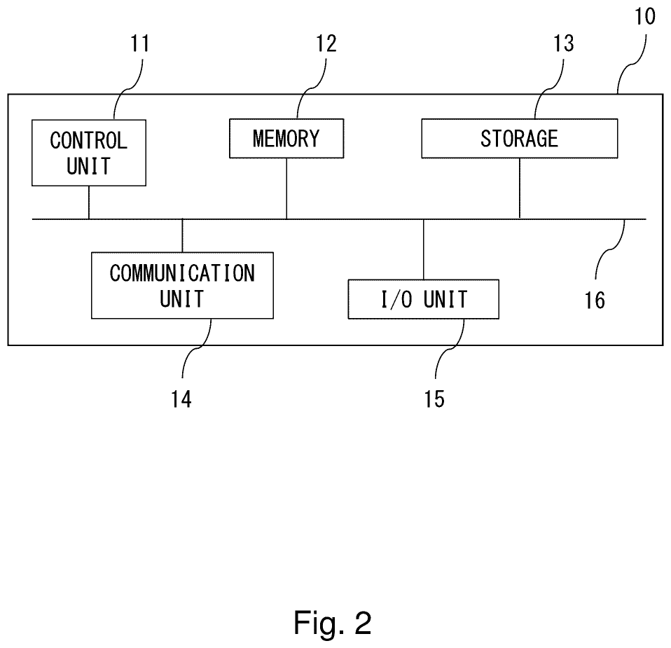

FIG. 2 is a figure illustrating an example of a hardware configuration of a computer that implements the server 10 according to the present embodiment. The computer includes at least a control unit 11, a memory 12, a storage 13, a communication unit 14, and an I/O unit 15. These are electrically connected to each other through a bus 16.

The control unit 11 is an arithmetic unit that controls the operation of the entire server 10, controls the transmission and reception of data between the elements, and performs information processing necessary for the execution and authentication processing of the application. For example, the control unit 11 is a processor such as a CPU (Central Processing Unit) and performs information processing by executing a program stored in the storage 13 and deployed in the memory 12.

The memory 12 includes a main memory comprised of a volatile storage device such as DRAM (Dynamic Random Access Memory) and auxiliary storage comprised of a flash memory or a non-volatile storage device such as a hard disk drive (HDD). The memory 12 is used as a work area of the control unit 11, and also stores a BIOS (Basic Input/Output System) executed when the server 10 starts, various configuration information, and the like.

The storage 13 stores various programs, such as application programs. A database containing the data used for each process may be constructed in the storage 13.

The communication unit 14 connects the server 10 to the network. The communications unit 14 communicates directly with external devices or via network access points, for example, in the form of a wired LAN (local area network), wireless LAN. Wi-Fi (Wireless Fidelity, registered trademark), infrared communication. Bluetooth (registered trademark), near distance or non-contact communication, and the like.

The I/O unit 15 is, for example, an information input device such as a keyboard, a mouse, a touch panel, and an output device such as a display.

The bus 16 is commonly connected to each of the above elements to transmit, for example, address signals, data signals, and various control signals.

Since the hardware configuration of a computer or a terminal such as a smartphone realizing the user terminal 20 according to the present embodiment is the same as that of the hardware configuration example of the server 10 illustrated in FIG. 2, an explanation is omitted.

### <Software Configuration Example>

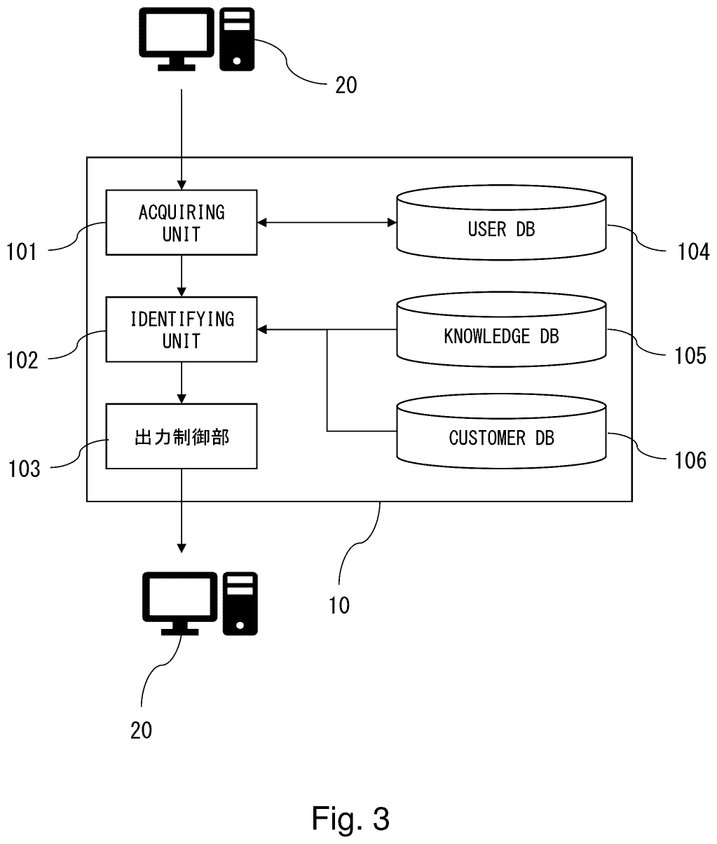

FIG. 3 is a figure illustrating an example of the software configuration of the server 10 according to the present embodiment. The server 10 includes the acquiring unit 101, the identifying unit 102, the output controlling unit 103, the user DB (database) 104, the knowledge DB (database) 105, and the customer DB (database) 106. The acquiring unit 101, the identifying unit 102, and the output controlling unit. 103 may be realized by reading out a program stored in the storage 13 into the memory 12 and executing it. Further, the user DB 104, the knowledge DB 105, and the customer DB 106 may be implemented as part of the storage area provided by memory 12 and storage 13. Note that the user DB 104, the knowledge DB 105, and the customer DB 106 may be implemented as part of an external storage area provided by one or more servers other than the server 10.

The acquiring unit 101 has a function to acquire information regarding the status of the user. The information regarding the status of the user is stored, for example, in the user DB 104. Further, the information regarding the status of the user may be retrieved from the user terminal 20. The status of the user is included in the user data stored in the user DB 104.

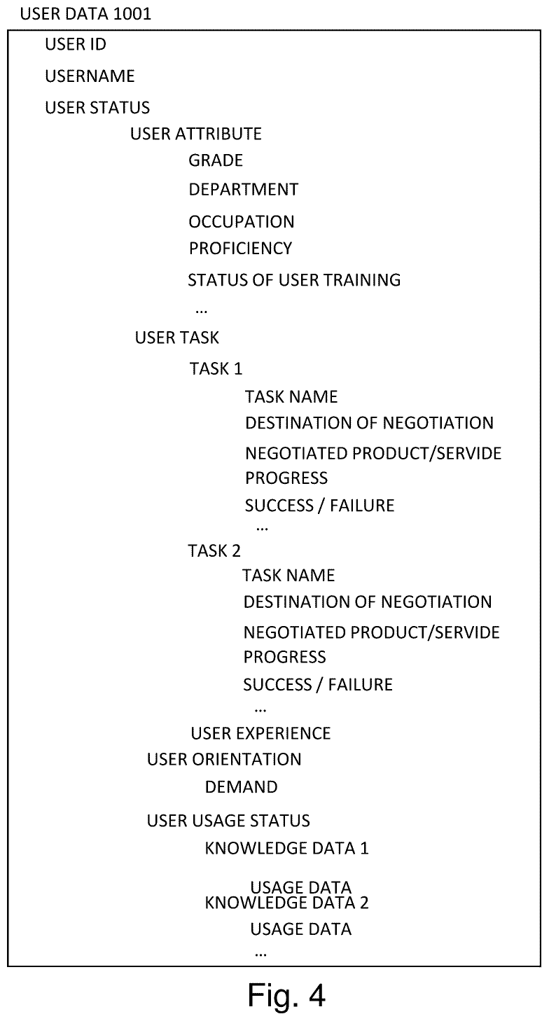

FIG. 4 is a figure illustrating an example of the content of the user data stored in the user DB 104 according to the present embodiment. As shown in FIG. 4, the user data 1001 in accordance with the present embodiment may include the user ID which identifies the user data, the username and information regarding the user status. The information regarding the user status may include, for example, the user attribute, the user tasks, the experience of the user, the orientation of the user, and the information of the usage status by the user.

The user attribute indicates information about user attributes. The user attribute may include, for example, the appropriate grade of the user in the organization, the department to which the user belongs, the occupation of the user, and information regarding the performance, the behavior and the ability of the user. The grade of the user is, for example, one that indicates the level of performance within the company. The title of the user represents the role and authority such as chief or section chief. The occupation of the user may be the specific job description such as sales or accounting personnel. The ability of the user is a parameter that indicates the level of acquisition of skill sets or mindsets required by the user's organization. The attribute of the user may also include information on the status of the user's training. The information on the status of the user's training may include information on the training of the learning course provided to the user in the organization. If the learning course consists of knowledge data stored, for example, in the knowledge DB 105, information on the training of the learning course may include information about the progress of the learning course being learned or the usage of the knowledge contained in the learning course. Such user attributes can be obtained, for example, from input from a user (including other users), other sales support services, personnel management services, and the like.

The user task indicates information about the tasks the user is responsible for. A user task may include one or more tasks. The user task may include current tasks and may include tasks that have been or will be performed in the future. The information regarding these tasks may include, for example, information of the task name, the destination for business negotiation, the negotiated product or service, the progress, and the success/failure. The information about the destination for business negotiation may include, for example, information about the industry of the destination for business negotiation from which the order is received, the size of the industry of destination of the interview, the size of the destination for business negotiation, the person in charge at the destination for business negotiation, and the business performance with the destination for business negotiation. The information on the negotiated product or service may include, for example, information on the type, the amount, the price, etc. of product or service proposed/proposing to or accepted by the destination for business negotiation. The information regarding the progress may include, for example, information about the progress of the sales (such as the stage of the company's understanding, competitive rationalization, customer understanding, product explanations, hearings, proposals, closings, etc., and the number of sales to the customers, etc.). The information on success or failure may include information on the success or failure of business in past tasks. In other words, the information of the user task may include a task that the user failed or had difficulty in negotiating, progress in sales, information in phases, etc. By using such information, appropriate knowledge data to overcome a weak phase of sales or difficult customer can be provided to the user.

The user task may include one or more tasks. The user task may include a current task and may include a task that was or will be performed. The information about these tasks may include, for example, information about the task name, the destination for business negotiation, the negotiated product or service, the progress, and success or failure. The information about the destination for business negotiation may include, for example, information about the industry of the destination for business negotiation from which the order is received, the size of the industry of destination of the interview, the size of the destination for business negotiation, the person in charge at the destination for business negotiation, and the business performance with the destination for business negotiation. The information on the negotiated product or service may include, for example, information on the type, the amount, the price, etc. of product or service proposed/proposing to or accepted by the destination for business negotiation. The information regarding the progress may include, for example, information about the progress of the sales (such as the stage of the company's understanding, competitive rationalization, customer understanding, product explanations, hearings, proposals, closings, etc., and the number of sales to the customers, etc.). The information on success or failure may include information on the success or failure of business in past tasks. In other words, the information of the user task may include a task that the user failed or had difficulty in negotiating, progress in sales, information in phases, etc. By using such information, appropriate knowledge data to overcome a weak phase of sales or difficult customer can be provided to the user.

The experience of the user is a combination of the user task information described above and indicates information on the result and experience of the business negotiation tasks that the user has been assigned to date. The experience of the user may include, for example, information about success/failure in the previous business negotiation. Specifically, the experience of the user may include information about successful and unsuccessful events at the user's customer, product, or negotiation phase, such as from which industry or customer the user receives a large number of orders which negotiation phase the user has been frequently unsuccessful, and so on. The experience of the user may also be linked to information on the usage of the knowledge used in each negotiation phase for each customer's product, as described below. By using such information, appropriate knowledge data can be provided to the user to overcome a difficult sales phase or difficult customer.

The orientation of the user indicates information on the career wishes of the user in the organization, requests to the organization, improvement points, etc. For example, if the user wishes to manage sales in the future, as well as sales practices, the orientation of the user may include information about such personnel preferences. The information about such orientation of the user may be obtained, for example, by conducting a questionnaire to the user.

The usage status of the user indicates information on the usage of the knowledge by the user. The information on the usage status of the user may include the utilization data of the knowledge data by the user. The utilization data of the knowledge data may include, for example, a history of the usage of the knowledge data by the user such as creating, viewing, editing, bookmarking, evaluating (e.g., feedback such as ‘like’), and sharing to the outside. If the knowledge data is used for learning purposes, the information on the usage of the knowledge data may include information on the usage of the knowledge data by the user through learning. In the learning, if the learning course has been developed with multiple knowledge data, the information on the usage of the knowledge data may include information on the user's use of the learning course (e.g., status of non-learning, learning, completion, etc.).

For example, suppose the user accesses an interface (e.g., a web browser) for knowledge sharing by the information processing system 1 using the user terminal 20. In this case, the acquiring unit 101 identifies the accessing user and acquires user data corresponding to the user from the user DB 104. Such user data includes information about the status of the user.

The identifying unit 102 has the function of identifying at least one knowledge data from a plurality of knowledge data based on the acquired information about the status of the user. Specifically, the identifying unit 102 first accesses the knowledge DB 105 and acquires the knowledge information of one or more knowledge data stored in the knowledge DB 105. The identifying unit 102 identifies the knowledge information that satisfies the predetermined condition for the status of the user based on the acquired information about the status of the user. The identifying unit 102 identifies the knowledge data that has knowledge information that satisfies the predetermined condition. The identifying unit 102 may identify knowledge data to which the information shown below that meets the predetermined condition specified by the status of the user relate. Various types of information described below may be used in combination for processing by the identifying unit 102.

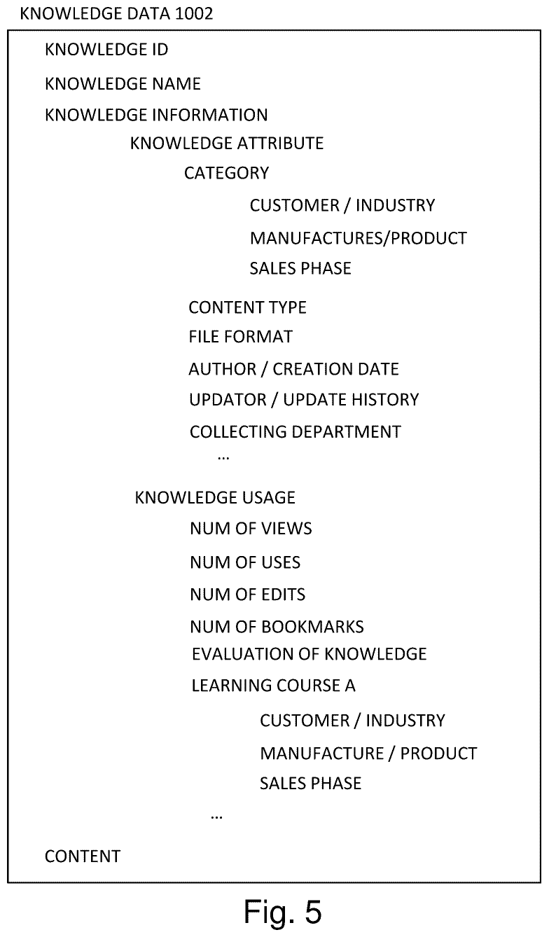

FIG. 5 is a figure illustrating an example of the content of the knowledge data stored in the knowledge DB 105 according to this embodiment. As shown in FIG. 5, the knowledge data 1002 in accordance with this embodiment may include the knowledge ID that identifies the knowledge data, the knowledge name, knowledge information, and content. The knowledge information may include, for example, information on knowledge attributes and knowledge usage. Such knowledge information is the information used to identify knowledge data based on information about the status of the user and the customer task information (characteristics of the business negotiation) by means of the identifying part 102.

The knowledge attribute indicates information about the attribute of the knowledge. The knowledge attribute may include, for example, information such as the category, the content type, the author/creation date, the updater/update history, relevant knowledge and the collecting department. The category is the attribute that attached to the knowledge categorized by, for example, the product category, the industry category or the file format. Specifically, the category may specify which customer the knowledge is for, which product is to be addressed, and which business phase the knowledge should be used. The content type means, for example, the goods or service corresponding to the content, the client's industry, the size of the client's industry, the size of the client's enterprise, or the location or timing suitable for use. Such content type may include, for example, at least one of a business use and a learning use. The relevant knowledge means knowledge that is manually or automatically linked to the knowledge. The collecting department may indicate the department that compiled the knowledge data and added information on the content type of the knowledge attribute as described above. The knowledge attribute may also include information about the space associated with that knowledge. The space is, for example, the category in which knowledge is allocated to each function of the organization. In other words, the space that is a knowledge attribute indicates which work and training stage or situation the knowledge will correspond to. More specifically, if the knowledge is sales-related materials, the space may be divided into “in-house understanding.” “competitor understanding.” “customer understanding.” “product explanation.” “customer example.” “hearing.” “customer proposal.” “closing.” “template.” and “training.” and so forth.

The knowledge usage indicates information on the use of knowledge data. The information about the knowledge usage may include, for example, the number of times the knowledge data is viewed, the number of use of the knowledge data (the use here is a practical use as used in the description in the business, etc.), the number of times the knowledge data is edited, the number of bookmarks on the knowledge data or the evaluation of the knowledge (e.g., feedback such as ‘like’, etc.), the history of the use of the knowledge users' information or sharing to the outside. Further, the content means the content itself contained in the knowledge data (e.g., which is composed of text, images, video, audio, etc.). The information on the use of knowledge data may also include information associated with the customer, product, or business phase, such as for which customer the information is used to receive orders, for which product the information is used to receive orders, or for which business phases the information is used.

The identifying unit 102 may identify at least one knowledge data based on, for example, information about the user's attributes. Specifically, the identifying unit 102 may identify at least one knowledge data based on the user's grade and/or occupation. By using the user's grade and/or occupation, it is possible to present appropriate knowledge data to the user based on the user's position in the organization. The identifying unit 102 may also identify at least one knowledge data based on the user's level of proficiency. As a result, for example, when the user who has been newly transferred to the sales division is going to catch up the sales task, it is possible to present materials about the client to which the proposal was made and information about competitors, etc., instead of suddenly presenting materials for the sales proposal. In this manner, the identifying unit 102 can present the knowledge to be viewed by the user in accordance with the user's situation by using information about the user's attributes.

The identifying unit 102 may also identify at least one knowledge data based on, for example, information from other users having attributes that are identical or related to user attributes. Specifically, information on the knowledge data used by other users can be used by using information from users with attributes that are identical to or related to the user's attributes (attributes that indicate that they belong to the same department as the user or that they are contemporaries with the user). As a result, it is possible to present to the user the knowledge data available to other users in the same situation.

The identifying unit 102 may also identify at least one knowledge data using, for example, information about the user's task. Specifically, the identifying unit 102 may use information relating to the task relating to the counterpart of the user (e.g., task relating to the client to which the business is to be negotiated). In this case, the knowledge data corresponding to the details of the client's business negotiation and the status of the client can be presented. Such information about the user's task may include, for example, information about the status of the user's order received and the status of the source of the order such as from which industry of customers the user receives the order. The information about the user's task may also include information about the progress of each phase of the negotiation in which the user received orders. The information on progress in each phase may include, for example, information on the progress of business negotiation and the status of business negotiation in each phase, such as the low progress rate in phase B. Alternatively, the identifying unit 102 may identify the knowledge data based on, for example, the information of the user's past business negotiation. For example, the knowledge data may be identified based on the information such as the phase, the customer, the product, the knowledge data used, etc. of the business negotiation that the user has failed in the past. As a result, the knowledge data that should be used by the user to succeed in the next and subsequent business negotiation may be presented. The identifying unit 02 may also identify the knowledge data using, for example, information about the task of the other user. Specifically, the identifying unit 102 may identify the knowledge data based on information on the status of the usage of the knowledge data used by the other user having similar tasks as the user. Such information, such as the status of the customer and the content of the business negotiation, may, for example, be extracted from the customer data stored in the customer DB 106.

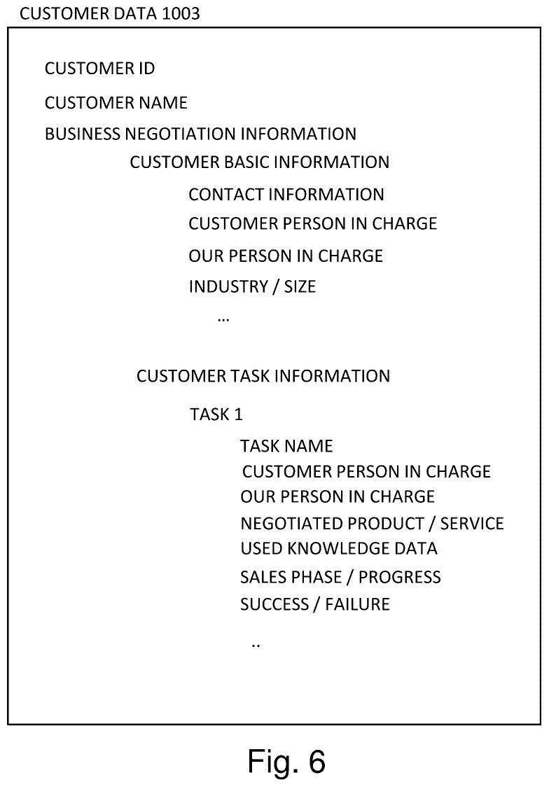

FIG. 6 is a figure illustrating an example of the content of the customer data stored in the customer DB 106 according to the present embodiment. As shown in FIG. 6, the customer data 1003 according to the present embodiment may include the customer ID that identifies the customer data, the customer name, and the customer information. The business negotiation information may include, for example, customer basic information and customer task information.

The customer basic information may include information about the customer and the industry such as contact information, person in charge in the customer, person in charge in the company and industry/size, and size of the customer's industry. The customer task information includes task information about the client. The task information may include information about the current task and may include information about the past or future task. For example, the customer task information may include the task name, the person in charge, the person in charge within the company (the user), the product or service related to the business negotiation, the progress (the sales phase), and the success/failure.

For example, the customer task information may be information associated with each business negotiation. In other words, the customer task can correspond to each business negotiation. For example, the customer task information includes information about the phase of the negotiation. The customer task information may also include information on the knowledge data used in the business negotiation, etc.

The identifying unit 102 may extract information about the client's status by reference to the customer data and identify the knowledge data based on such information. As a result, it is possible to automatically present to the user the knowledge data that is considered appropriate for the client's situation. That is, the identifying unit 102 may identify the knowledge data based on the business negotiation information. The business negotiation information may include customer information pertaining to the business negotiation, product information pertaining to the business negotiation, and information pertaining to the phase of business negotiation. For example, the identifying unit 102 may identify the knowledge data based on the customer information pertaining to the business negotiation. For example, the identifying unit 102 may identify the knowledge data based on the product information pertaining to the business negotiation. For example, the identifying unit 102 may identify the knowledge data based on the information about the progress of the task (e.g., the phase of the business negotiation). Specifically, if the progress of the task is that the customer's hearing has been completed, the identifying unit 102 may identify the knowledge data to be used in the next phase of the customer's hearing. In addition, when the user has failed in a particular negotiation phase of a particular customer, the identifying unit 102 may identify other knowledge data relating to the customer hearing. By identifying the knowledge data according to the progress of the task and the phase of the negotiation, it is possible to obtain the knowledge data that maximizes the effect of business for the client. For example, appropriate knowledge data, such as understanding a customer in the business of a particular product, can be presented to the user during the business negotiation phase with the client. In this way, even in the case of sales to the same client, appropriate knowledge data can be obtained according to the phase of the negotiation.

Note that the identifying unit 102 may identify the knowledge data based on the customer task information (for example, information such as the characteristics of the business negotiation and the knowledge data used in the business negotiation) without using the user information. In other words, the identifying unit 102 may compare the customer task information with the attribute and the status of the usage of the knowledge data and identify one or more knowledge data matching the customer task information. For example, the identifying unit 102 may identify knowledge data based on at least one of the characteristics of the negotiation. i.e., the information of the customer to whom the business is negotiated, the information of the product to which the business is negotiated, and the business phase of the negotiation. The identified knowledge data may be the knowledge data that can have attribute and usage information that fit the characteristics of such negotiation. As a result, it is possible to obtain appropriate knowledge data according to the state of business negotiation. In this case, the user status information may or may not be used. When there are multiple customer task information or information on business negotiation, the identifying unit 102 may use them or combination thereof for the identification processing.

The identifying unit 102 may also identify at least one knowledge data based on information about the orientation of the user. For example, if the user wishes to transfer to the sales department, the information may be presented to the user regarding the client to which he/she may be assigned in the future, materials regarding the products sold to the client, information on competitors, etc. In this manner, the identifying unit 102 may use the information about the orientation of the user to present the knowledge to be viewed by the user in response to changes in the user's future situation. In addition, for example, in the search for knowledge, the identifying unit 102 may identify the knowledge data based on whether the user is looking for knowledge data for business purposes or for learning purposes. As a result, it is possible identify the knowledge data suitable for use by users in either business or learning, even knowledge data relating to specific clients and products, etc. The identification processing by the identifying unit 102 may be based on, for example, the information about the user's orientation and the information such as the search condition and the knowledge attribute.

The identifying unit 102 may also identify at least one knowledge data based on information about the status of the usage by the user. For example, if the user frequently uses or evaluates the knowledge data about a particular client, the identifying unit 102 may identify the knowledge data about the client that the user has not yet used. Conversely, if the user does not much use the same knowledge data as the knowledge data that is commonly used by the user, the identifying unit 102 may identify such knowledge data.

In addition, the identifying unit 102 may identify at least one knowledge data based on the status of usage by other users that is different from the user acquired by the acquiring unit 101. For example, when it is determined that the knowledge data which is commonly used by other users with similar status and is not used or is less used by the user, the identifying unit 102 may identify such knowledge data. As a result, the user may see the knowledge data which has been overlooked.

The identifying unit 102 may further use the information on the status of usage of the knowledge data in addition to the status of the user to identify the knowledge data. For example, the identifying unit 102 may identify the knowledge data that is widely viewed by other users belonging to the business that is the attribute of the user or that indicates information (evaluation information) on high evaluation of the knowledge data. As a result, it is possible to present the knowledge data on the sales that the user should see to the user by the information processing system 1 even if the user does not do anything. The information on inspection and evaluation as shown in FIG. 5, etc. may be used as the information on the status of usage of the knowledge data. As a result, it is possible to provide to the user more appropriate knowledge data based on the value of the knowledge data itself.

The identifying unit 102 may also identify the knowledge data based on the status information of the user and the customer data. For example, when the success rate is low in a phase (e.g., the customer proposal) of the sales process as the orientation of the user, the identifying unit 102 may identify the knowledge data indicating the tendency of the high success rate in such phase. Alternatively, the identifying unit 102 may identify the knowledge data by appropriately combining various information included in the user information with various information included in the customer data. As a result, it is possible to obtain appropriate knowledge data according to the characteristics of the user.

In addition, the identifying unit 102 may identify the knowledge data with respect to the evaluation information attached to the knowledge data using information on the status of the user who has evaluated the information. For example, the knowledge data that is highly valued by high-performing users may be presumed to be very important knowledge data. Therefore, such knowledge data may also be heavily applied to other users. As a result, the user may obtain better knowledge data.

As described above, the identifying unit 102 may identify the knowledge data based on information about the user's status, thereby allowing the user to obtain knowledge data suitable for the user's circumstance. In addition, by using the status of the usage of the knowledge data and the customer data, it is possible to obtain the high quality knowledge data for the user and obtain the client-specific knowledge data.

Note that, for example, the identifying unit 102 may perform the process of identifying the knowledge data using a machine learning model in which the information related to the status of the user is used as the input data and the knowledge data is used as the output data. Such machine learning model may be constructed using a variety of machine learning techniques as appropriate.

Further, such a machine learning model may also be updated as appropriate by feedback based on right or wrong knowledge data which is the output data. The identifying unit 102 may also identify the learning courses to be taken by the user based on the information about the status of the user. Such learning course may consist of one or more knowledge data stored in the knowledge DB 105, as described above. The information about the learning course may include information about the attribute or usage of the learning course. For example, the information relating to the attribute of the learning course may be information indicating which of the learning courses should be used for business negotiation for which customers, which product should be described, or in which business phase should be used. Such information may be presented in the form of tag or category. The information about the status of the usage of the learning course may be information on for which customer it is used in business negotiation, about which product it is used in describing, or in which business phase it is used. The identifying unit 102 may identify appropriate learning course for the user based on, for example, information about the status of the user and information about the learning course. As a result, it is possible to obtain the appropriate learning course the user should take as training.

The output controlling unit 103 has the function of outputting information on at least one identified knowledge data. For example, the output controlling unit 103 may output an object or the like representing the knowledge data on the interface displayed on the user terminal 20 described above.

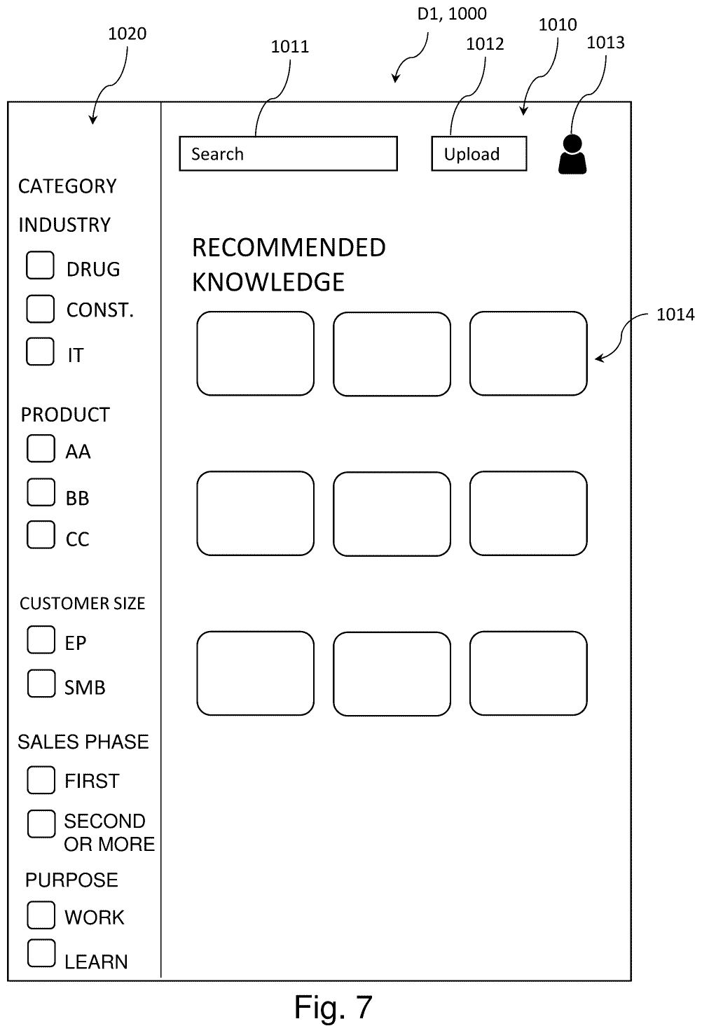

FIG. 7 is a figure illustrating an example of an aspect of the output display according to the output controlling unit 103 according to the present embodiment. In the example shown in FIG. 7, the example of the screen 1000 of the service for knowledge sharing is displayed on the display unit D1 of the user terminal 20. The screen 1000 includes the main screen 1010 and the sub screen 1020. The main screen 1010 may include, for example, the query input form 1011 for entering text in retrieving knowledge data, the upload button 1012 for uploading knowledge data, the user button 1013 for manipulating information about the user, and the knowledge data object 1014 for displaying a list of the knowledge data. The sub screen 1020 may also include the selection screen configured by the checkbox or the like to select the category for narrowing down the knowledge data. The checkbox may include, for example, the options such as customer's industry, product, industry size, customer size, business phase or usage of knowledge.

The knowledge data identified by the identifying unit 102 is displayed, for example, in conjunction with the knowledge data object 1014 on the screen 1000 being viewed by the user. For example, when selecting the knowledge data object 1014, the associated knowledge data is displayed. In this way, the user may access the knowledge data to be viewed by simply displaying such the screen 1000. The portion of the content of the knowledge data may be displayed on the knowledge data object 1014 by placing the mouse pointer or the like on the knowledge data object 1014. As a result, it is possible to view the content of the knowledge data by previewing without opening the knowledge data. Further, the method of aligning the knowledge data object 1014 is not particularly limited, but may include, for example, a way so that the knowledge data object 1014 regarding more suitable knowledge data is positioned more upper place, a way so that the information indicating a higher priority with numbers, symbols, etc., attached to the knowledge data object 1014, or a way so that the knowledge data object 1014 is displayed in a manner indicating that it is more important than other knowledge data (e.g., size, color, effect, etc.). The knowledge data to be viewed by the user may also be displayed by the knowledge data object 1014 based on the information on the business negotiation, product information, phase of sales, etc. corresponding to the business negotiation that the user is currently in charge of. In addition, on such the screen 1000, the knowledge data to be viewed by the user may be displayed by the knowledge data object 1014 based on the status of the user (e.g., success or failure of past business negotiation, business phase when success or failure occurs, business negotiation information, etc.). Such processing may be performed by the output controlling unit 103.

The example of the output control by the output controlling unit 103 is not limited to the example illustrated in FIG. 7. For example, on the screen for managing individual business negotiation, the knowledge data identified based on the phase of business negotiation (sales), the customer information, the product information, the user information, etc. may be displayed on the screen. As a result, when engaging in the business negotiation, appropriate knowledge data is preset according to the status of such business negotiation and the status of user, so that appropriate knowledge data may be used even if the user himself/herself does not find the knowledge data necessary for business negotiation.

Further, the example of the output and the aspect of the output hereof relating to the knowledge output by the output controlling unit 103 is not limited to the example described above. For example, the output controlling unit 103 may output information on the agenda of the business negotiation on the above-described management screen of the business negotiation. The information on the agenda of the business negotiation can be identified by the identifying unit 102 based on, for example, the knowledge data associated with the past customer task information (the knowledge data is not limited to so-called documents, but also information related to the minutes associated with the customer task information, the used knowledge data, success or failure of the business negotiation, etc.). In addition, the output controlling unit 103 may output information such as the templates for mail or message, etc. to be sent to the client after the business negotiation. Such information may also be identified by the identifying unit 102 based on the knowledge data associated with the past customer task information and the business negotiation. Similarly, the output controlling unit 103 may output the address information to the document when the document shared with the client is stored in the cloud server or the like after the business negotiation.

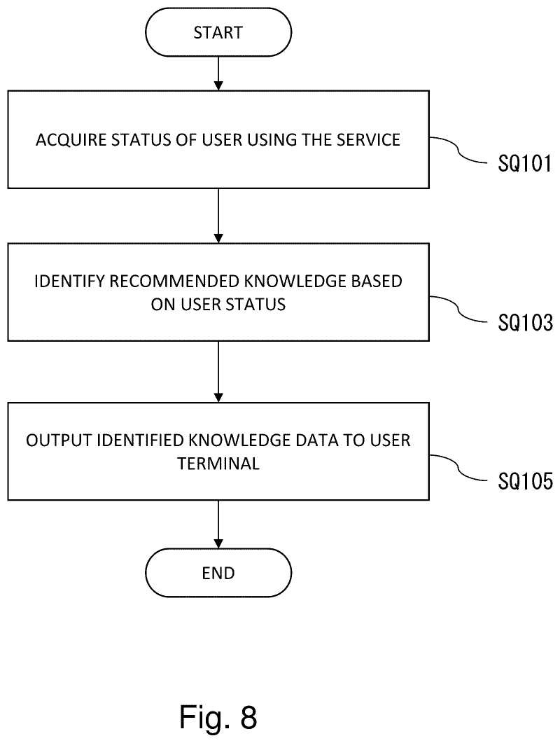

FIG. 8 is a flow chart illustrating a series of controls of the information processing system 1 according to the present embodiment. First, when the user uses the service provided by the information processing system 1, the acquiring unit 101 acquires information about the status of the user using the service (Step SQ101).

Next, the identifying unit 102 identifies the knowledge data to be recommended based on the user's status (step SQ103). In addition to the status of the user, the identifying unit 102 may identify the knowledge data by using information related to the knowledge data (e.g., the status of usage), the customer data, the status of usage of other users, the attributes of other users, and the like.

Next, the output controlling unit 103 outputs the identified knowledge data to the user terminal 20 (step SQ105).

As described above, according to the information processing system 1 according to the present exemplary embodiment, at least one of a plurality of knowledge data stored in the server or the like is identified based on the information such as the status of the user, and such knowledge data is presented to the user. As a result, the user can obtain the knowledge that they are encouraged to see, based on his/her own circumstance, the status of usage of the knowledge data of other users, and the status of tasks for the clients, etc. Accordingly, even if the user does not understand the large amount of knowledge data stored in the server, etc., the knowledge data that should be viewed by the user may be obtained appropriately according to the status of the user, etc.

Note that the sales data is used as knowledge data in this embodiment, but the present technology is not limited to such example. For example, in other embodiments of the art, the knowledge data relating to the organization's personnel and education may be used as the knowledge data, or any other material relating to the organization's activities may be used as knowledge data in the art. For example, the task regarding the counterpart of the user within the organization may be the task on the subject of personnel evaluation such as the superior or subordinate or the subject of the evaluation.

In this embodiment, it is described that the task information, such as the business negotiation, is managed in association with the customer data in the customer DB 106, but the present technology is not limited to such an example. For example, the information about the business negotiation may be stored as negotiation data for each business negotiation in the business negotiation DB (database), which is not shown in the figures. In this case, as described above, information about the business negotiation may include information on the person in charge of business negotiation (the user), the customer of the business negotiation, the product related to the business negotiation, the phase of the business negotiation (sales), the success or failure of the business negotiation, the knowledge data used for the business negotiation, etc. The identifying unit 102 may identify appropriate knowledge data based on the information obtained from the negotiation DB as described above.

While the preferred embodiments of the present disclosure have been described in detail with reference to the accompanying drawings, the technical scope of the present disclosure is not limited to such examples. It is obvious that a person with ordinary skill in the art of the present disclosure may fall within the scope of the technical ideas set forth in the scope of the present disclosure, and it is also understood that these may fall within the scope of the technical idea of the present disclosure.

The apparatus described herein may be implemented as a single device and may be implemented by a plurality of devices (e.g., a cloud server) or the like, all or part of which are connected by a network. For example, the control unit 11 and the storage 13 of the information processing server 10 may be implemented by a different server connected to each other by a network.

A series of processing by the apparatus described herein may be implemented using either software, hardware, and a combination of software and hardware. A computer program for realizing each function of the information processing server 10 according to the present embodiment may be created and implemented on a PC, etc. Computer readable recording media can also be provided in which such computer programs are stored. The recording medium may be, for example, a magnetic disk, an optical disk, an optical magnetic disk, a flash memory, or the like. The computer program may also be distributed, for example, over a network, without using a recording medium.

Also, the processes described herein with a flow chart diagram may not necessarily be performed in the order illustrated. Some processing steps may be performed in parallel. Additional processing steps may also be employed, and some processing steps may be omitted.

Also, the effects described herein are illustrative or exemplary only and are not limited. In other words, the art of the present disclosure may have other effects as will be apparent to one of ordinary skill in the art from the description herein, as well as the above effects or in lieu of the above effects.

Note that the following configurations are also within the technical scope of the present disclosure.

### (Item 1)

An information processing method that presents to a user appropriate knowledge data among a plurality of knowledge data stored on one or more servers, the method, executed by a processor, comprising:
acquiring information regarding a status of the user;
identifying at least one knowledge data among the plurality of knowledge data based on the acquired information regarding the status of the user; and
outputting information regarding the identified at least one knowledge data.

### (Item 2)

The information processing method according to item 1, wherein:
the status of the user includes information regarding the attribute of the user, and
the at least one knowledge data is identified based on information regarding the acquired attribute of the user.

### (Item 3)

The information processing method according to item 2, wherein information regarding the attribute of the user includes information regarding at least one of the user's grade, department, occupation, and proficiency.

### (Item 4)

The information processing method according to item 2 or 3, identifying the at least one knowledge data based on information from other users having an attribute that is identical or related to an attribute of the user.

### (Item 5)

The information processing method according to any one of items 1 to 4, wherein the status of the user includes information regarding a task of the user.

### (Item 6)

The information processing method according to item 5, wherein the task of the user includes a task on the counterpart of the user.

### (Item 7)

The information processing method according to item 5 or 6, wherein the information regarding the task of the user includes information regarding a progress of the task.

### (Item 8)

The information processing method according to any one of items 1 to 7, wherein the status of the user includes information regarding an orientation of the user.

### (Item 9)

The information processing method according to any one of items 1 to 8, wherein the status of the user includes information regarding a status of usage of the knowledge data stored in the server by the user.

### (Item 10)

The information processing method according to item 9, wherein the processor:
further acquires information regarding a status of usage by other user who is different from the user; and
determines at least one knowledge data from the plurality of knowledge data based on acquired information regarding the status of the usage by the other user and the status of the user.

### (Item 11)

The information processing method according to any one of items 1 to 10, wherein the at least one knowledge data among the plurality of knowledge data is identified further using information regarding a status of usage of a plurality of knowledge data stored in the server.

### (Item 12)

The information processing method of item 11, wherein the status of the usage of the knowledge data includes a status of usage by other user of the knowledge data, the other user is different from the user.

### (Item 13)

The information processing method of item 12, wherein the status of the usage of the knowledge data includes evaluation information for the knowledge data by the other user.

### (Item 14)

The information processing method of item 13, wherein the evaluation information for the knowledge data includes information regarding a status of the user who evaluated the knowledge data.

### (Item 15)

The information processing method according to any one of items 1 to 14, wherein the processor identifies at least one knowledge data among the plurality of knowledge data based on business negotiation information.

### (Item 16)

The information processing method of item 15, wherein
the business negotiation information includes at least one of customer information regarding a business negotiation, product information regarding a business negotiation, and information regarding a phase of business negotiation.
wherein the processor identifies at least one knowledge data among the plurality of knowledge data based on at least one or a combination of the customer information regarding the negotiation, the product information regarding the negotiation, and the information regarding the phase of the negotiation.

### (Item 17)

The information processing method according to any one of items 1 to 16, wherein a learning course to be taken by the user is determined based on information regarding the acquired status of the user.

### (Item 18)

The information processing method according to any one of items 1 to 17, wherein the knowledge data includes knowledge data regarding sales performed by an organization who owns the knowledge data and/or knowledge data regarding the organization.

### (Item 19)

An information processing system that presents to a user appropriate knowledge data among a plurality of knowledge data stored on one or more servers, the system comprising:
acquiring unit that acquires information regarding a status of the user;
identifying unit that identifies at least one knowledge data among the plurality of knowledge data on the acquired information regarding the status of the user; and
outputting unit that outputs information regarding the identified at least one knowledge data.

### (Item 20)

A program for making an information processing system, that presents to a user appropriate knowledge data among a plurality of knowledge data stored on one or more servers.
the program executed by a computer makes the computer function;
an acquiring unit that acquires information regarding a status of the user;
an identifying unit that identifies at least one knowledge data among the plurality of knowledge data on the acquired information regarding the status of the user; and
an output controlling unit that outputs information regarding the identified at least one knowledge data.

### REFERENCE SIGNS LIST

1 Information Processing System
10 Information Processing Server
20 User Terminal
101 Acquiring Unit
102 Identifying Unit
103 Output Controlling Unit
104 User DB
105 Knowledge DB
106 Customer DB

1. An information processing method that presents to a user appropriate knowledge data among a plurality of knowledge data regarding sales stored on one or more servers, the method, executed by a processor, comprising:
acquiring information indicating a proficiency of the user regarding the sales;
identifying at least one knowledge data among the plurality of knowledge data according to the acquired proficiency of the user; and
outputting information regarding the identified at least one knowledge data.

2. The information processing method of claim 1, wherein the at least one knowledge data is identified based on information on an other user having an attribute that is identical or regarding the an attribute of the user.

3. The information processing method of claim 1, wherein the at least one knowledge data is identified based on information regarding a task of the user.

4. The information processing method of claim 1, wherein the at least one knowledge data is identified based on a task on the counterpart of the user.

5. The information processing method of claim 3, wherein the at least one knowledge data is identified based on information regarding a progress of the task.

6. The information processing method according to claim 1, wherein the at least one knowledge data is identified based on information regarding an orientation of the user.

7. The information processing method according to claim 1, wherein the at least one knowledge data is identified based on information regarding a status of usage by the user of the knowledge data stored in the server.

8. The information processing method according to claim 7, wherein the method, executed by a processor, further comprising:
acquiring information regarding the status of usage by other user that is different from the user,
wherein the at least one knowledge data among the plurality of knowledge data is identified based on the acquired information regarding the status of the usage by the other user and the status of the user.

9. The information processing method according to claim 1, wherein the at least one knowledge data among the plurality of knowledge data is identified further using information regarding a status of usage of a plurality of knowledge data stored in the server.

10. The information processing method of claim 9, wherein the status of the usage of the knowledge data includes a status of usage by other user of the knowledge data, the other user is different from the user.

11. The information processing method of claim 10, wherein the status of the usage of the knowledge data includes evaluation information for the knowledge data by the other user.

12. The information processing method of claim 11, wherein the evaluation information for the knowledge data includes information regarding a status of the user who evaluated the knowledge data.

13. The information processing method according to claim 1, wherein the processor identifies at least one knowledge data among the plurality of knowledge data based on business negotiation information.

14. The information processing method of claim 13, wherein
the business negotiation information includes at least one of customer information regarding a business negotiation, product information regarding a business negotiation, and information regarding a phase of business negotiation,
wherein the processor identifies at least one knowledge data among the plurality of knowledge data based on at least one or a combination of the customer information regarding the negotiation, the product information regarding the negotiation, and the information regarding the phase of the negotiation.

15. The information processing method according to claim 1, wherein a learning course to be taken by the user is determined based on information regarding the acquired status of the user.

16. The information processing method according to claim 1, wherein the knowledge data includes knowledge data regarding sales performed by an organization who owns the knowledge data and/or knowledge data regarding the organization.

17. An information processing system that presents to a user appropriate knowledge data among a plurality of knowledge data regarding sales stored on one or more servers, the system comprising:
an acquiring unit that acquires information indicating a proficiency of the user regarding the sales;
an identifying unit that identifies at least one knowledge data among the plurality of knowledge data according to the acquired proficiency of the user; and
an output controlling unit that outputs information regarding the identified at least one knowledge data.

18. A program for making an information processing system, that presents to a user appropriate knowledge data among a plurality of knowledge data regarding sales stored on one or more servers,
the program executed by a computer makes the computer function;
an acquiring unit that acquires information indicating a proficiency of the user regarding the sales;
an identifying unit that identifies at least one knowledge data among the plurality of knowledge data according to the acquired proficiency of the user; and
an output controlling unit that outputs information regarding the identified at least one knowledge data.
